(19) United States
(12) Patent Application Publication
(10) Pub. No.: US 2006/0081711 A1
(43) Pub. Date: Apr. 20, 2006

(54) Color-identifying system for colored barcode and a method thereof

(76) Inventors: Junxiang Zhao, Taichung (TW); Yi Fang Chen, Taichung (TW); Zhi Geng Tan, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/952,864

(22) Filed: Sep. 30, 2004

(51) Int. Cl. G06K 7/12

(52) U.S. Cl. 235/462.04

(57) ABSTRACT

A color-identifying system for colored barcode and a method thereof. The system includes a picture-processing sensor for picking up picture data, an MCU for processing the picture data and an LCD for showing the processed data. The color-identifying method for the colored barcode includes steps of obtaining data, removing major noise, removing minor noise, expansion treatment, finding out center of black block, finding out suitable four-point combination black blocks and barcode information analysis.

### BACKGROUND OF THE INVENTION

The present invention is related to a color-identifying system for colored barcode and a method thereof.

FIGS. 9 and 10 show a basic structure of a conventional black-and-white barcode. Such barcode includes character symbol structure (FIG. 9) and barcode structure (FIG. 10). In the character symbol structure, black and white and wide and narrow lines are combined to represent specific character symbols such as Arabic numerals or English alphabets for describing different messages. In the barcode system, the black lines are bars, while the white lines are spaces. The bars and spaces can be divided into wide bar 1, narrow bar 2, wide space 3 and narrow space 4 which represent different messages. Referring to FIG. 9, the barcode structure is composed of a series of character symbols by a certain rule. The components of the barcode include left margin white a, starting symbol b, character symbol c, middle spacing symbol d, ending symbol e, checking symbol f and right margin white g as shown in FIG. 10. The black-and-white barcode is calculated according to a common international encoding rule. For example, according to the calculation formula of the EAN-13 code, the values of the barcode can be calculated so as to check out the messages represented by the barcode. However, in practice, the above black-and-white barcode can hardly represent all the messages of the products.

In order to solve the above problem, colored barcode has been developed. However, the permutation of the colored barcode is different from that of the black-and-white barcode. The identification of the colored barcode is also different from the black-and-white barcode. Therefore, it is tried by the applicant to provide a colored barcode which contains more messages and is easy to identify.

### SUMMARY OF THE INVENTION

It is therefore a primary object of the present invention to provide a color-identifying system for colored barcode and a method thereof.

The color-identifying system for colored barcode of the present invention includes a picture-processing sensor for picking up picture data, an MCU for processing the picture data and an LCD for showing the processed data. The picture-processing sensor picks up the picture data and sends the picture data to the MCU, in the case of error of identification, a warning sound being emitted, a control member, address and several I/O being disposed in the MCU, the data being processed by the MCU and shown on the LCD.

The MCU and the subscriber interface can employ RS232 interface for communicating with personal computer. The power source can be 6V, that is, four 1.5V cells.

The color-identifying method for colored barcode of the present invention includes steps of: obtaining data; removing major noise, when collecting the data, noise being led in, when the noise reaches a certain range, the noise being defined as major noise and removed; removing minor noise, in the case that the size of the noise does not reach the range of the major noise, the noise being defined as minor noise and removed; expansion treatment, the structural elements being expanded and magnified to find out the locating center point; finding out center of black block, after expansion treatment, the edge data of the black blocks being found out and the center of each black block being simultaneously calculated; finding out suitable four-point combination black blocks, in the case that there are more than four black blocks, four-point combination black blocks being found out so as to define the center point of each color block of the colored barcode for successive analysis; and barcode information analysis, the barcode information analysis being performed according to the colored barcode encoding rule.

The present invention can be best understood through the following description and accompanying drawings wherein:

### BRIEF DESCRIPTION OF THE DRAWINGS

FIG. 1 is a diagram of the structure of the color blocks of the colored barcode of the present invention;

FIG. 2 is a block diagram of the color-identifying system for colored barcode of the present invention;

FIG. 3 is a flow chart of the color-identifying method for colored barcode of the present invention;

FIG. 4A shows a state prior to removing the major noise;

FIG. 4B shows a state after removing the major noise;

FIG. 5A shows a state prior to removing the minor noise;

FIG. 5B shows a state after removing the minor noise;

FIG. 6A shows a state prior to expansion treatment;

FIG. 6B shows a state after expansion treatment;

FIG. 7 shows that the centers of the black blocks are found out;

FIG. 8 shows that the four-point combination black blocks are found out;

FIG. 9 shows the character structure of a conventional black-and-white barcode; and

FIG. 10 shows the structure of a conventional black-and-white barcode.

### DETAILED DESCRIPTION OF THE PREFERRED EMBODIMENT

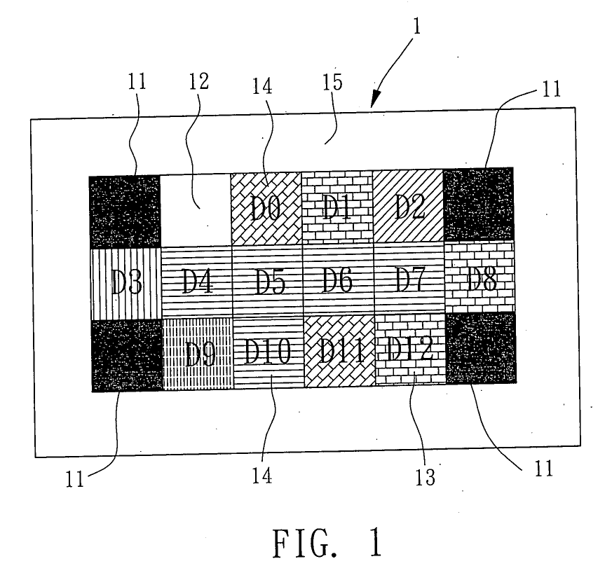

Please refer to FIG. 1 which shows a colored barcode 1 of the present invention. The colored barcode 1 is composed of 6×3 color blocks. Four black locating color blocks 11 in four corners serve to locate and identify the colored barcode. The second leftmost color block of the upper row is a white starting color block 12 serving as a starting position of the colored barcode. The second rightmost color block of the low row is a checking color block 13. The remaining data color blocks 14 respectively have ten easily distinguishable colors to serve as message carriers for respectively representing numerals 0˜9.

In order to more effectively distinguish the colors, each color block preferably has a size of 2×12 pixels. In addition, a white margin frame 15 is left along the periphery of the colored barcode. The width of the margin frame 15 is about one half of the width of the color block.

With the above 6×3 colored barcode exemplified, excluding the four black locating color blocks 11 and the white starting color block 12 for judging the starting position, the remaining thirteen color blocks can represent a character symbol of 13 units places. The amount of the messages represented by such colored barcode is equal to that of the conventional EAN-13 code.

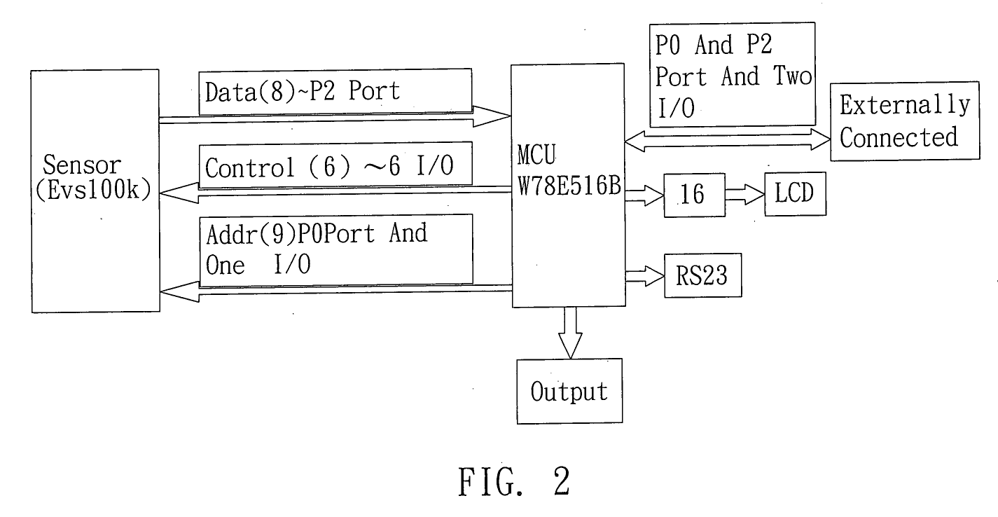

Referring to FIG. 2, the color-identifying system for the colored barcode of the present invention includes a picture-processing sensor 20, an MCU 30 and an LCD 40. The picture-processing sensor 20 can pick up picture data and send the picture data to the MCU 30 for processing. After processed, the data are shown on the LCD 40. The MCU 30 and the subscriber interface can employ RS232 interface for communicating with the personal computer. The power source can be 6V, that is, four 1.5V cells.

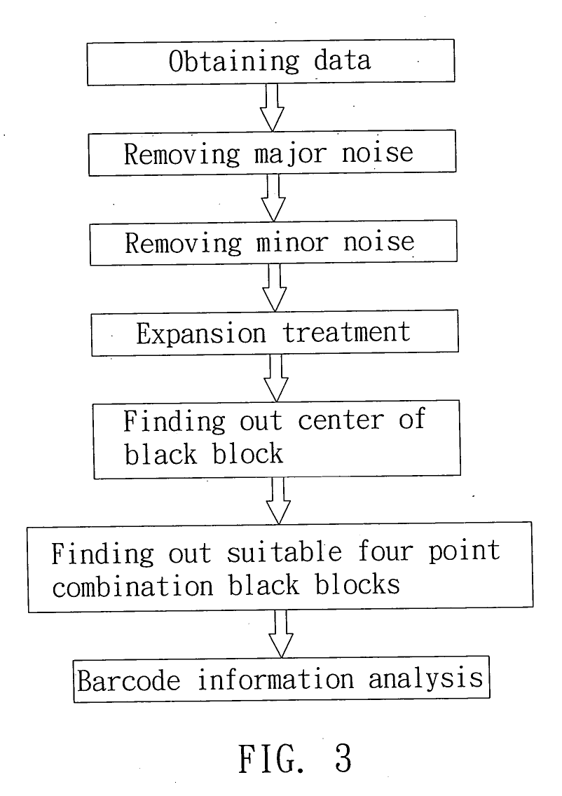

Referring to FIG. 3, the color-identifying method for the colored barcode of the present invention includes steps of obtaining data, removing major noise, removing minor noise, expansion treatment, finding out center of black block, finding out suitable four-point combination black blocks and barcode information analysis.

The above steps are described as follows:

Obtaining data: It is satisfied that the total pixels are 96×60 and the size of the color block floats within 8×8˜15×15.

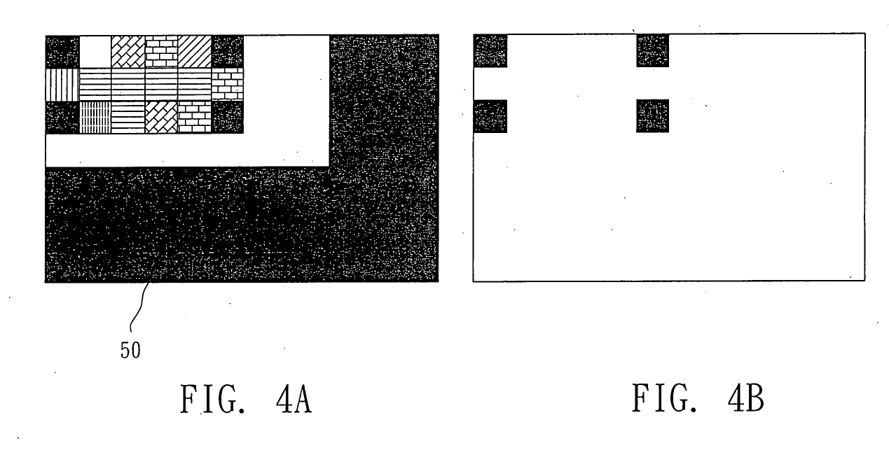

Removing major noise: When collecting the data, noise is often led in. Referring to FIG. 4A, when the noise reaches a certain range, only in the case that the wave filter calculates that the number of blockpoints is more than 22, it is deemed that the point is within the range of major noise and defined as major noise 50. At this time, the major noise is removed via a 1×19 wave filter. The noise is filtered off in X direction and Y direction. FIG. 4B shows that the noise has been filtered off.

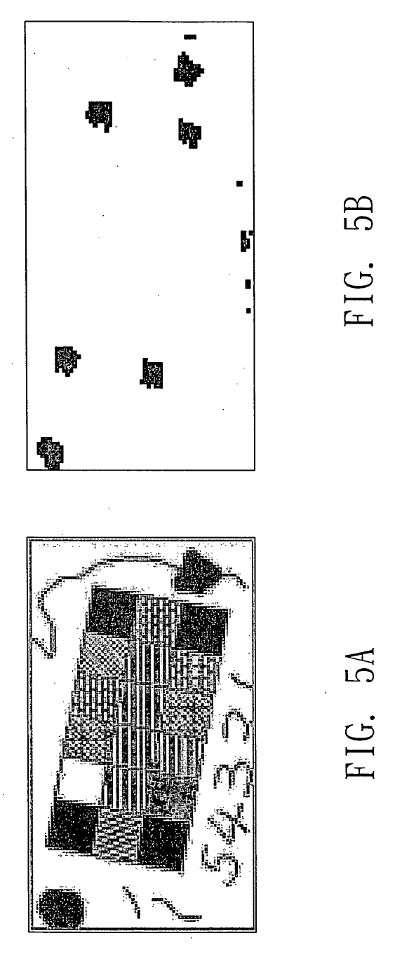

Removing minor noise: In the case that the size of the noise does not reach the range of the major noise and the number of the black point in the wave filter is less than 22, it is deemed that the point pertains to minor noise as shown in FIG. 5A. The minor noise is removed via a 5×5 wave filter. FIG. 5B shows that the noise has been removed.

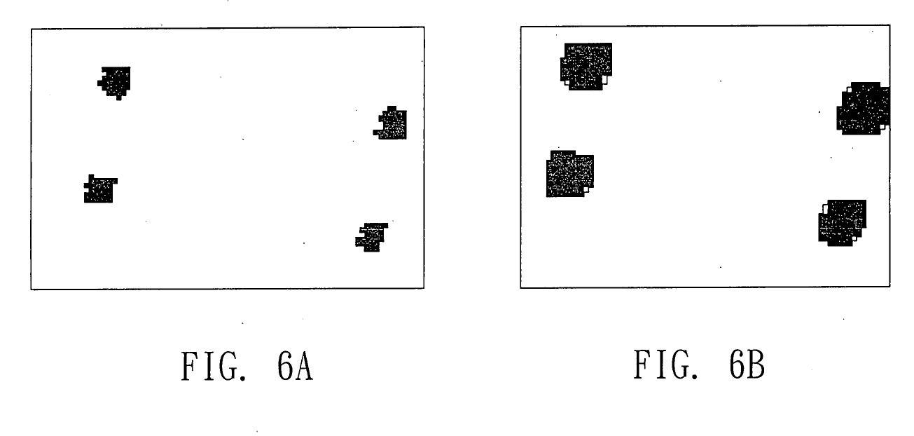

Expansion treatment: The structural elements are expanded and magnified to find out the locating center point. FIG. 6A shows a state prior to expansion treatment. The expansion treatment is such performed that a 5×5 structural element is first built. In the case that at least one point within the region of the structural element is black, then all the points within the region of the structural element are turned black. FIG. 6B shows a state after the treatment. The purpose of the treatment is to make it possible that the connecting lines between the edges of the black blocks form a quadrangle.

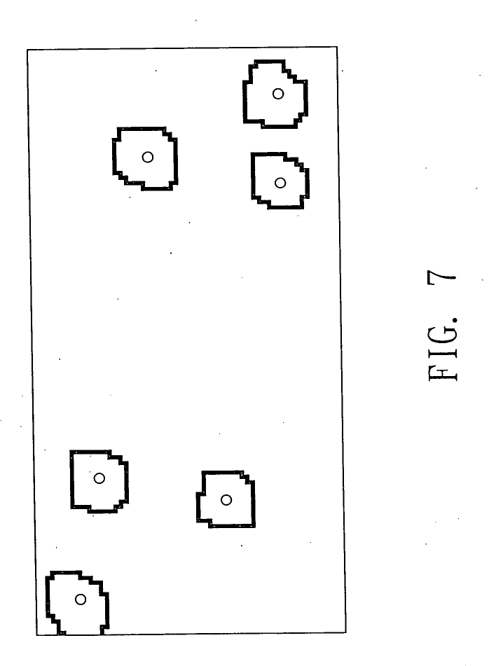

Finding out center of black block: After expansion treatment, the edge data of each black block are found out and the center of each black block is simultaneously calculated as shown in FIG. 7.

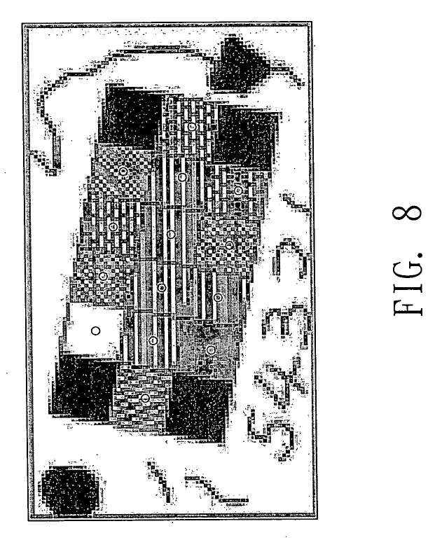

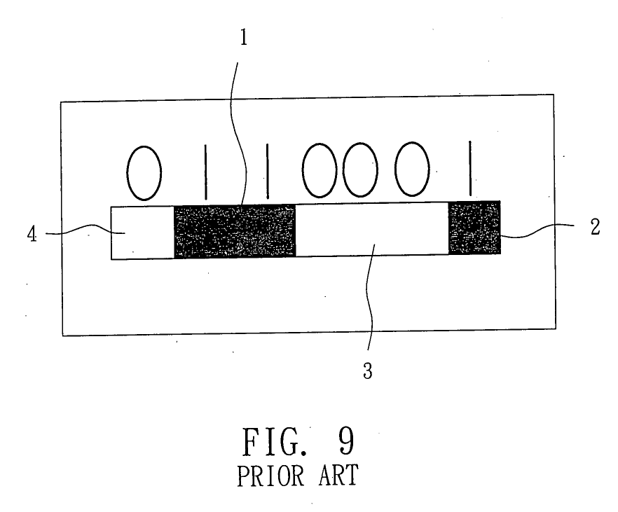

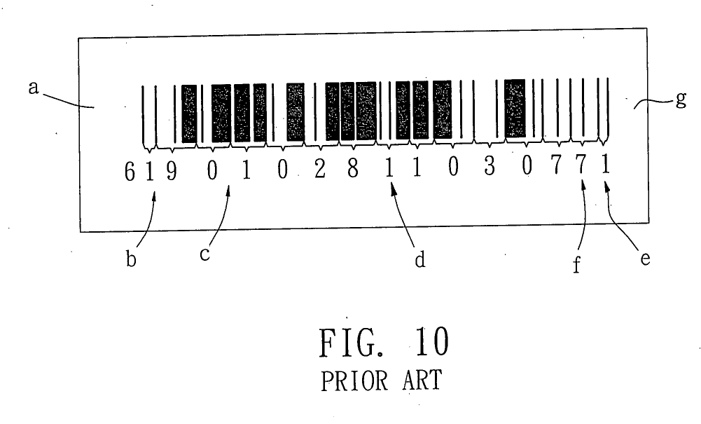

Finding out suitable four-point combination black blocks: In the case that there are more than four black blocks, via a combination calculation, a suitable four-point combination is found out so as to define the center point of each color block of the colored barcode as shown in FIG. 8 for successive analysis.

Barcode information analysis: the barcode information analysis is performed according to the colored barcode encoding rule.

According to the above colored barcode encoding rule, the colored barcode is composed of various color blocks (6×3) by a certain rule. FIG. 1 shows the structure of the colored barcode. The colored barcode is composed of locating color blocks 11, starting color block, checking color block 13, data color blocks 14 and white margin frame 15. The respective color blocks are described as follows:

The locating color blocks 11 are positioned in four corners of the colored barcode for locating the same. The locating color blocks 11 are black.

The starting color block 12 is a starting mark of the colored barcode. The starting color block 12 is white.

The data color blocks 14 (denoted by D0˜D1) are marked with specific colors. The relationship is shown by the following table:

| | Character | | | | | | | | | |
|---|---|---|---|---|---|---|---|---|---|---|
| | 0 | 1 | 2 | 3 | 4 | 5 | 6 | 7 | 8 | 9 |
| Color | red | magenta | yellow | green | bottle | sky | blue | navy | purple | pink |
| | | | | | green | blue | | blue | | |
| Checking | A | B | A | B | A | B | A | B | A | B |
| letter | | | | | | | | | | |

The checking color block (denoted by D12) is used to check whether the color block is correct.

Supposing the data of the colored barcode are as follows:

| | | | | | | | | | | | | |
|---|---|---|---|---|---|---|---|---|---|---|---|---|
| D0 | D1 | D2 | D3 | D4 | D5 | D6 | D7 | D8 | D9 | D10 | D11 | D12 |

wherein:

D0˜D2 are national codes, D3˜D5 are manufacturer codes and D6˜D12 are product codes, then the checking code is calculated as follow:
SUM=(D1+D3+D5+D7+D9+D11)×5+D0+D2+D4+D6+D8+D10

The value of D12 is equal to the remainder of SUM divided by 10.

The margin frame is white for enclosing the colored barcode to facilitate identification.

The relationship between D0 and D1˜D6 is shown by the following table:

| National code | checking of data A, B of left six units places | | | | | |
|---|---|---|---|---|---|---|
| D0 is ensured | D1 | D2 | D3 | D4 | D5 | D6 |
| 0 | A | A | A | A | A | A |
| 1 | A | A | B | A | B | B |
| 2 | A | A | B | B | A | B |
| 3 | A | A | B | B | B | A |
| 4 | A | B | A | A | B | B |
| 5 | A | B | B | A | A | B |
| 6 | A | B | B | B | A | A |
| 7 | A | B | A | B | A | B |
| 8 | A | B | A | B | B | A |
| 9 | A | B | B | A | B | A |

In conclusion, the character series of the colored barcode is ensured according to the following sequence:

D0, that is, national code is first ensured. D1˜D6 are numbered according to the rule of D0 and led in by the rule. D7˜D11 are valued randomly and then the value of the checking code D12 is calculated.

Accordingly, the barcode of the present invention is encoded by means of the system which picks up the colors of the barcode and converts the colors and spaces and calculates the values. According to the present method, 12 kinds of colors including black and white can be calculated. Through the encoding rule, the corresponding representing codes of the color blocks of the barcode can be found out and thus the information represented by the entire barcode can be obtained. Accordingly, the meaning of the barcode can be read.

The above embodiment is only used to illustrate the present invention, not intended to limit the scope thereof. Many modifications of the above embodiment can be made without departing from the spirit of the present invention.

What is claimed is:

1. A color-identifying system for colored barcode, comprising:
a picture-processing sensor for picking up picture data;
an MCU for processing the picture data; and
an LCD for showing the processed data, whereby the picture-processing sensor picks up the picture data and sends the picture data to the MCU, in the case of error of identification, a warning sound being emitted, a control member, address and several I/O being disposed in the MCU, the data being processed by the MCU and shown on the LCD.

2. A color-identifying method for colored barcode, comprising steps of:
obtaining data;
removing major noise, when collecting the data, noise being led in, when the noise reaches a certain range, the noise being defined as major noise and removed;
removing minor noise, in the case that the size of the noise does not reach the range of the major noise, the noise being defined as minor noise and removed;
expansion treatment, the structural elements being expanded and magnified to find out the locating center point;
finding out center of black block, after expansion treatment, the edge data of the black blocks being found out and the center of each black block being simultaneously calculated;
finding out suitable four-point combination black blocks, in the case that there are more than four black blocks, four-point combination black blocks being found out so as to define the center point of each color block of the colored barcode for successive analysis; and
barcode information analysis, the barcode information analysis being performed according to the colored barcode encoding rule.

3. The color-identifying method for colored barcode as claimed in claim 2, wherein in the step of obtaining data, it is satisfied that the total pixels are 96×60 and the size of the color block floats within 8×8˜15×15.

4. The color-identifying method for colored barcode as claimed in claim 2, wherein the major and minor noises are removed by a wave filter.

5. The color-identifying method for colored barcode as claimed in claim 2, wherein the expansion treatment is such performed that a 5×5 structural element is first built, in the case that at least one point within the region of the structural element is black, then all the points within the region of the structural element being turned black, whereby the connecting lines between the edges of the black blocks can form a quadrangle.

6. The color-identifying method for colored barcode as claimed in claim 2, wherein in the step of obtaining data, it is satisfied that the total pixels are 96×60 and the size of the color block floats within 8×8˜15×15.

7. The color-identifying system for colored barcode as claimed in claim 1, wherein the MCU and the subscriber interface can employ RS232 interface for communicating with personal computer.

8. The color-identifying system for colored barcode as claimed in claim 1, wherein the power source can be 6V, that is, four 1.5V cells.

9. The color-identifying method for colored barcode as claimed in claim 2 or 4, wherein the major noise is removed via a 1×19 wave filter, the major noise being filtered off in X direction and Y direction, the minor noise being removed via a 5×5 wave filter.
